(19) United States
(12) Patent Application Publication
(10) Pub. No.: US 2010/0313129 A1
(43) Pub. Date: Dec. 9, 2010

(54) Self-Expanding AD Unit

(76) Inventor: Michael Hyman, Bellevue, WA (US)

Correspondence Address: SoCAL IP LAW GROUP LLP, 310 N. WESTLAKE BLVD. STE 120, WESTLAKE VILLAGE, CA, 91362, US

(21) Appl. No.: 12/796,534

(22) Filed: Jun. 8, 2010

Related U.S. Application Data
(60) Provisional application No. 61/184,922, filed on Jun. 8, 2009.

(51) Int. Cl. G06F 3/048; G06F 3/01

(52) U.S. Cl. 715/719; 715/800; 715/781

(57) ABSTRACT

Methods for presenting self-expanding content in a web page. A client computer may receive, from a server computer, a content unit including initial visual content and a self-contained expansion element. The client computer may display all or a portion of the initial visual content in an initial display window. After displaying the initial visual content, the client computer may execute the self-contained expansion element, which causes the client computer to perform actions including: defining a size and location for an expanded display window larger than the initial display window; hiding elements of the web page determined to interfere with the expanded display window; loading, from the server, expanded visual content; and displaying at least a portion of the expanded visual unit in the expanded display window.

### RELATED APPLICATION INFORMATION

This patent claims priority from Provisional Application No. 61/184,922, filed Jun. 8, 2009, entitled “Video Player Invocation From Standard IAB Units”, incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to placing advertisements in web pages accessed via the Internet, and specifically to advertisements that expand in size in response to a viewer action.

2. Description of the Related Art

The Internet and the World Wide Web have made a vast body of knowledge available to anyone with a computer and a network connection. As of 2009, the World Wide Web included about 180 million websites.

Within this patent, the term “publisher” means a company, government entity, or other organization that provides a web site accessible via the internet. Publishers may provide all of the content of their web sites, or may embed content provided by other sources. For example, many websites are supported, at least in part, by advertisements presented within web pages. Publishers of ad-support web sites may sell space on their web pages for advertisements.

In this patent, an “ad broker” is a company that places ads in publisher web pages. The ad broker may broker such ad space between publishers and advertisers. The ad broker may act as a media buyer that purchases ad space from publishers and sells the space to various advertisers or advertising agencies.

A publisher may be paid and an advertiser may be charged for each “impression”, or each time the advertiser's ad appears on the publisher's website. The publisher may be paid, and the advertiser may be charged, an additional “clickthrough” amount for each viewer who interacts with the ad, for example by clicking on the ad or an element within the ad.

Traditionally, web pages were written in Hypertext Markup Language (HTML). Currently, to provide a variety of content including audio, video, and/or animation, web pages may be written in a combination of HTML and other platforms including Extended Markup Language (XML), Java, and Adobe Flash. Most ads to be embedded in web pages are written using Flash. Flash is a multimedia platform including a suite of program instructions, data structures, and file formats used to create objects that can be played or rendered by a Flash player coupled to a web browser. Flash supports text, graphics, animation, audio, video, and/or viewer interaction.

Most web page ads conform to standards set by an industry association, the Interactive Advertising Bureau (IAB). The IAB has defined a plurality of standard ad formats, commonly referred to as “ad units”. Within this patent, the term “ad unit object” refers to the programming code and associated data that causes an ad unit to be displayed within a web page. Conventional ad unit objects are usually Flash objects hosted on servers operated by an advertising broker or a third-party provider. An ad unit object may be written by the advertising broker, the third-party provider, or the advertiser.

To provide more effective presentation of advertising content, a web page ad may be “expandable”, which is to say that the area, or display window, on a display device in which the ad is displayed may be configured to temporarily grow in size in response to a viewer action such as moving a cursor over the ad using a mouse or other pointing device. Currently, ad expansion is accomplished using an ad expansion program object that must be embedded within the host web page. Typically the ad expansion program object is written by an ad broker or ad provider. The ad expansion program object may be qualified off-line by the web page publisher to ensure that the ad expansion program object and the associated expandable ads do not interfere with the content of the publisher's web page. When qualified, the ad expansion program object must be embedded in every web page that may receive expandable ads. Since there is no present standard for expandable ads, each ad broker/provider may supply different ad expansion program objects. Given the complexity of the preparation required, many publisher web pages do not allow expandable ads.

### DESCRIPTION OF THE DRAWINGS

FIG. 1 is a block diagram of a network environment.

FIG. 2 is a block diagram of a computing device.

FIG. 3 is a flow chart of a method for providing a self-expanding content unit.

FIG. 4 is a graphical depiction of content unit.

FIG. 5 is a flow chart of a method for providing a video image within a self-expanding content unit.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

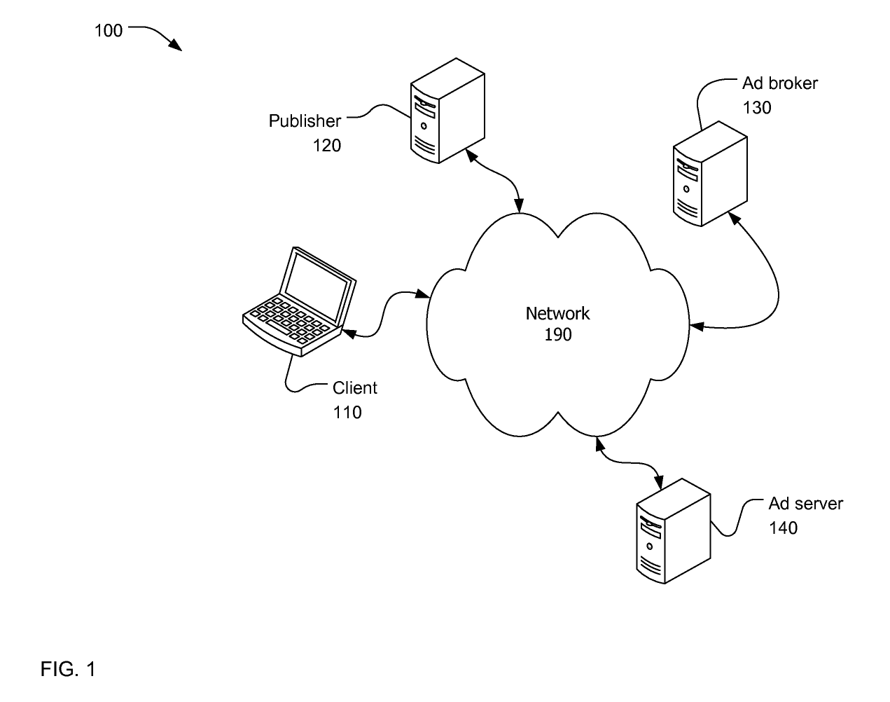

Referring now to FIG. 1, a network environment 100 may include a client computer 110, a publisher server 120, an ad broker server 130, and an ad server 140 coupled via a network 190. The network 190 may be or include the Internet. Although FIG. 1 shows, for ease of explanation, a single client computer and three servers, it must be understood that millions of clients and many thousands of servers may be connected to the Internet simultaneously.

The client computer 110 may be used by a viewer to access the Internet including the World Wide Web. In this context, a “viewer” is a person who uses a client computer to view web pages. Although shown as a portable computer, the client computer 110 may be any computing device including, but not limited to, a desktop personal computer, a portable computer, a laptop computer, a computing tablet, a set top box, a video game system, a personal video recorder, a telephone, or a personal digital assistant.

The publisher server 120 may store and “serve”, or provide, web pages in response to requests received via the network 190 from other devices such as the client computer 110. When a web page to be served includes one or more regions allocated for ad units, the publisher server may request the ad broker server to provide data defining the ad units to be incorporated into the web page.

The ad broker server 130 may store contracts or rules defining relationships between the ad broker and a plurality of publishers and between the ad broker and a plurality of advertisers. When the publisher server 120 requests data identifying an ad to be placed in a web page, the publisher server may select an advertisement and provide the requested identifying data.

The ad server 140 may store one or more ad unit objects defining one or more ads. After an ad has been selected by the ad broker server 130, the ad server may provide the ad unit object for the select ad in response to a request from the publisher server 120 or the client computer 110.

The ad broker server 130 and the ad server 140 may be physically or geographically separate, or the ad broker server 130 and the ad server 140 may be combined in a single server or cluster of servers. The ad broker server 130 and the ad server 140 may be controlled by separate business entities or by a single business. Some or all of the publisher server 120, ad broker server 130 and the ad server 140 may be virtual servers within a cloud.

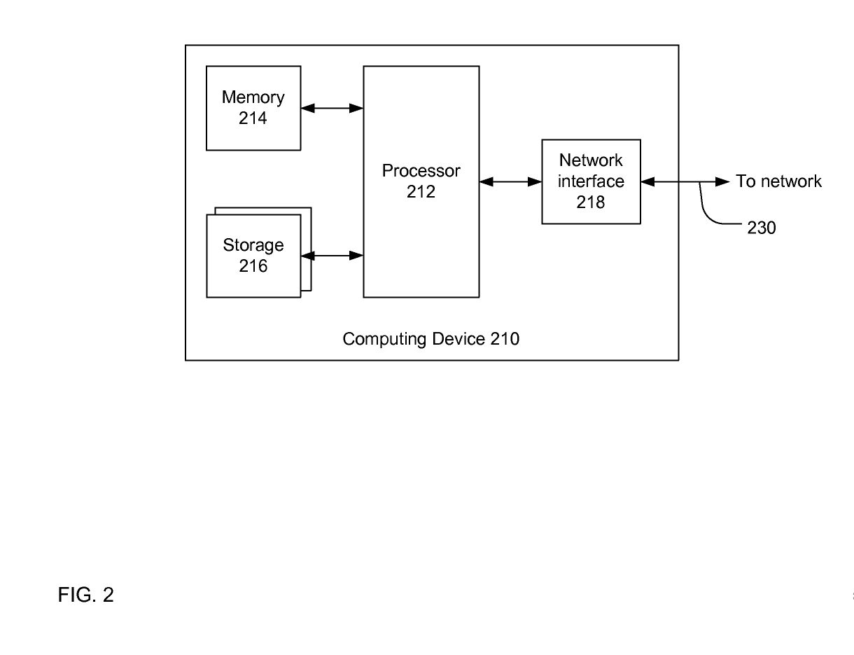

Each of the client computer 110, the publisher server 120, the ad broker server 130, and the ad server 140 may be a computing device 210, as shown in FIG. 2. The computing device 210 may include at least one processor 212, memory 214, and a network interface 218. Servers, in particular may contain a plurality of processors. The computing device 210 may include or be coupled to one or more storage devices 216. A client computer may also include or be coupled to a display device and user input devices, such as a keyboard and mouse, not shown in FIG. 2.

Each of the client computer 110, the publisher server 120, the ad broker server 130, and the ad server 140 may execute software instructions to perform the actions and methods described herein. The software instructions may be stored on a machine readable storage media a storage device such as the storage device 216. These storage media include, for example, magnetic media such as hard disks, floppy disks and tape; optical media such as compact disks (CD-ROM and CD-RW) and digital versatile disks (DVD and DVD±RW); flash memory cards; and other storage media. The term “storage media” is not intended to encompass a transient medium, such as a signal or a waveform, conveying software instructions or other data.

The client computer may run an operating system, including, for example, variations of the Linux, Microsoft Windows, Symbian, and Apple Mac operating systems. To access the Internet, the client computer may run a browser such as Microsoft Explorer or Mozilla Firefox, and an e-mail program such as Microsoft Outlook or Lotus Notes. Each of the publisher server 120, the ad broker server 130, and the ad server 140 may run an operating system and one or more application programs to perform the actions and methods described herein.

Each of the client computer 110 and the servers 120, 130, 140 may include various specialized units, circuits, firmware, software and interfaces for providing the functionality and features described here. The processes, functionality and features may be embodied in whole or in part in software executed by a processor. The hardware, firmware, and software and their functions may be distributed such that some function and features are performed by a processor and others by other devices.

Description of Processes

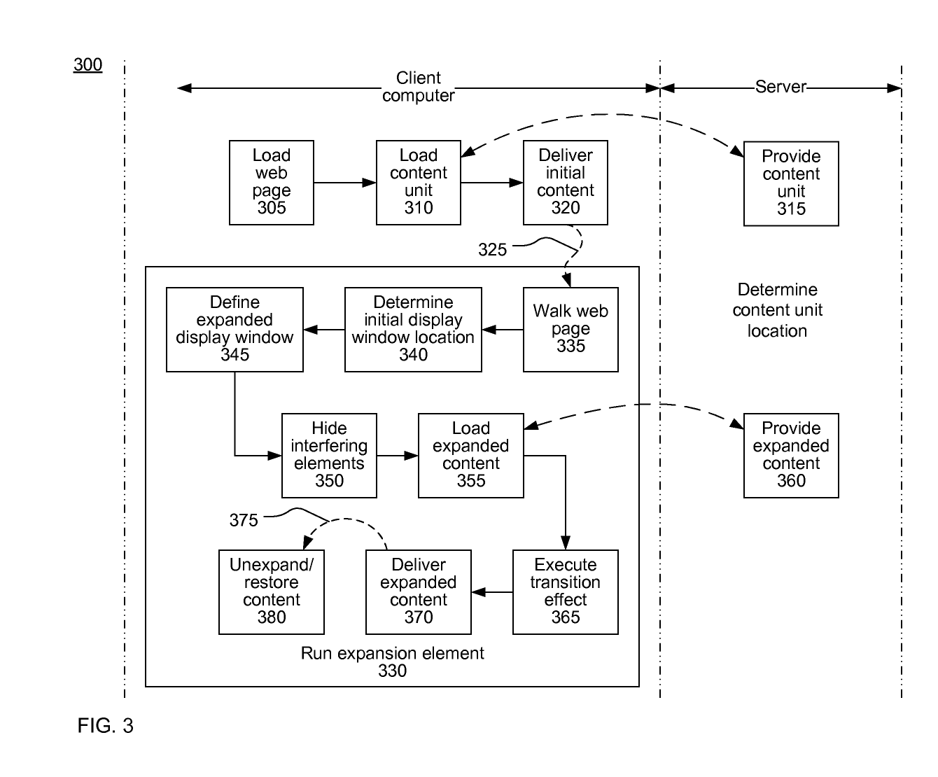

FIG. 3 is a flow chart of a process 300 for self-expanding content units. In this patent, the term “content unit” means content that is incorporated by a client computer into a web page, but is provided by a party other than the publisher of the web page. The content of the content unit is not a predefined constituent of the web page. Rather, the web page includes a space or placeholder for later-determined content unit to be loaded separately from the web page. Commonly, the content unit may be an ad unit. However, the process 300 may be used with other types of content. The process 300 may be performed by a client computer and a server, which may be the ad server 140 of FIG. 1, coupled by a network.

The process 300 may be considered to start at 305, when a client computer loads a web page, typically in response to an action by an operator or viewer. The process 300 may end when the viewer causes the client computer to leave the web page (not shown) loaded at 305. The viewer may leave the web page by clicking on a link within the web page, by entering the URL of a new web page, by closing a web browser, or in some other manner. The process 300 may terminate in response to a viewer action at any time during the process.

The process 300 will usually be cyclical in nature, since the process 300 may be repeated for some or all of plurality of web pages visited by the viewer while browsing the Web. The process 300 may be performed numerous times in parallel as web pages are concurrently provided to a large plurality of client computers. Actions 305-320 of the process 300 may also be performed multiple times in parallel if a single web page provides a plurality of advertisements.

At 305, the client computer may load a web page from a publisher server. After loading the web page from the publisher computer at 305, a browser program running on the client computer may render the web page for delivery to the viewer. The term “browser program” means a program configured for retrieving, viewing, and interacting with web pages. Examples of browser programs include Microsoft Internet Explorer, Mozilla Firefox, and Google Chrome. As part of rendering the first web page, at 310 browser program may cause the client computer to load a content unit from a server computer in accordance with information identifying the content unit contained in the web page. The client computer may load the content unit by first making a call to an ad broker server that, in turn, provides a URI or other information identifying the content unit. For example, at 310, the client computer may execute a script contained within the web page. When executed at 310, the script may cause the client computer to send a message requesting the content unit from the server computer. In response to the message from the client computer, the server may download the content unit to the client computer at 315.

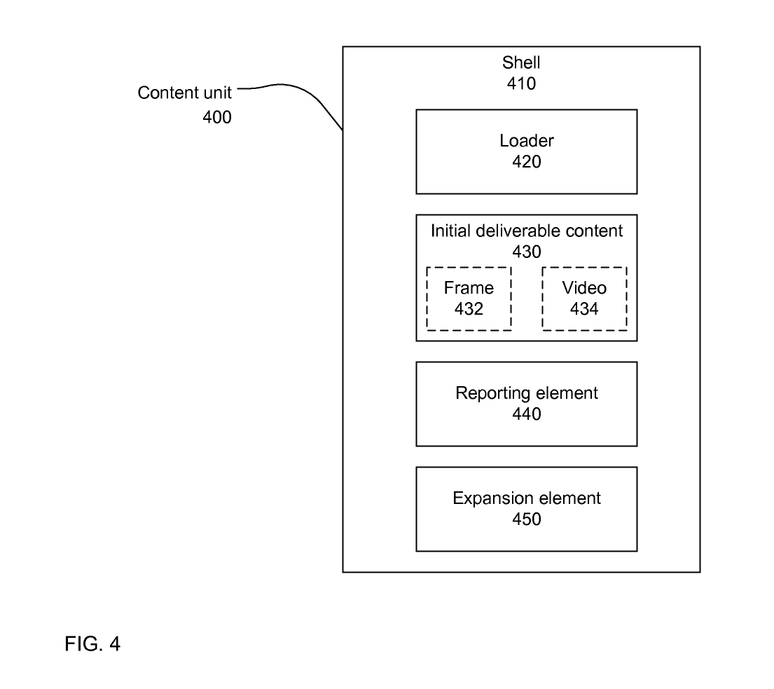

Referring now to FIG. 4, a content unit 400 may include deliverable content 430, which is the visual and audio content actually delivered to a viewer. The content unit 400 may also include non-deliverable content including a shell 410, a loader 420, an expansion element 440 and a reporting element 450.

The shell 410 may be executable HTML code or other code that forms an outer layer of the content unit 400. The shell 410 may include or manage the loader 420 to load other elements of the content unit. The shell 410 may also manage the interface between the content unit 400 and the client computer, the browser, and/or the viewer.

The deliverable content 430 may include instructions, data, and files required to generate and deliver an advertisement or other content within the web page loaded at 305. The deliverable content 430 may be or include, for example, a Flash object that may generate text, graphics, and/or animations and may load one or more images, video clips, and/or audio clips. In some cases, the deliverable content 430 may include a frame element 432 and a video element 434 which will be described in further detail subsequently.

The reporting element 440 may interface with the shell and a browser running on the client computer to accumulate and report data with respect to the viewer's interaction with the ad. The reporting element 440 may report data such as whether or not the ad was actually loaded, whether or not the ad was actually visible on the display device, how long the ad was actually visible, and whether or not the user interacted with ad.

The expansion element 450 may be an executable object, such as an HMTL object, a JavaScript object, ActionScript object, or a combination of these and other executable objects. The expansion element 450, when executed, may cause the client computer to perform the subsequently described actions to expand and contract the content unit in response to a predetermined viewer action. Since the expansion element 450 is loaded as part of the content unit 400, the expansion and contraction may occur without any cooperation or prior preparation of the host web page.

Referring back to FIG. 3, at 320, the client computer may deliver the initial deliverable content 430 that was loaded at 310. In this context, the term “deliver” specifically means providing the multimedia content of a web page or other on-line content to a viewer. Delivering the initial deliverable content 430 may include displaying static visual components, such as text and graphics, in an allocated area, or initial display window, within the web page on a display device coupled to the client computer. Delivering the initial deliverable content 430 may also include playing dynamic visual components, such as animations and video clips, within the initial display window. Delivering the content may also include playing one or more audio components. Some content units may include dynamic elements, such as animated graphics or video clips, that are only played in response to an action by the viewer. In such cases, the content unit is considered to be delivered when such dynamic elements are loaded and ready to be played.

After the deliverable content is delivered at 320, the process 300 may wait until a predetermined first viewer action 325 initiates execution of the expansion element 450. The predetermined first viewer action 325 may be, for example, clicking on the content unit displayed on a display device, or “mousing over” the content unit (moving a cursor over the displayed content unit using a mouse or other pointing device). Upon detection of the predetermined user action, the expansion element 450 that was loaded with the content unit at 310 may be executed at 330.

Executing the expansion element at 330 may cause the client computer to take a series of actions to temporarily incorporate an expanded content unit into the web page. The expanded content unit may include addition or different visual content displayed within an expanded display window larger that the initial display window. At 335, the client computer may “walk” the web page load at 305, which is to say the client computer may analyze the HTML and other code that defines the web page. The analysis may determine what elements are present in the web page that may interfere with the expanded display window. Elements that may interfere with the expanded display window may include, for example, elements such as iframe elements or Flash elements that do not strictly observe HTML z-index and layer stacking protocols. The expansion unit running on the client computer may access the code defining the web page via a browser application program interface (API).

At 340, a location of the initial display window within the web page may be determined. The location of the initial display window may be determined while walking the web page at 335 or by other inquiry to the browser. The initial display window may typically, but not necessarily, be located flush with either the left edge or the right edge of the web page.

At 345, the size and location of the expanded display window may be defined, at least in part, based on the location of the initial display window determined at 340. When the initial location is flush with the left edge of the web page, the display window will typically expand to the right and either or both of upwards and downwards. When the initial location is flush with the right edge of the web page, the display window will typically expand to the left and either or both of upwards and downwards. In the case where an initial display window is not flush with an edge of the web page, the display window may expand both to the left and to the right.

Web page elements located at 335 that may interfere with the expanded display window defined at 345 may be hidden at 350. A number of techniques may be used to hide elements within a web page. For example, a z-index value of an element may be changed such that the element is positioned on a layer behind the expanded display window. For further example, if the element to be hidden is governed by a cascading style sheet, the style sheet may be modified to include a declaration “display:none” to indicate that the element is not displayed. At 350, a list may be made of the elements that are hidden and either the actions taken to hide them or the action necessary to unhide them.

At 355, the client computer may request and load expanded deliverable content. The expanded deliverable content may be provided by the server at 360. When desired, the server may also download to the client computer an optional transition effect to be executed during the transition from the initial display window to the expanded display window. The transition effect may be, for example, an at least partially transparent display element that may be placed over the initial display window that, when executed, morphs or changes in some manner to introduce the expanded display window. Examples of a transition effect include a wipe or dissolve or animated graphics. The transition effect may include an API to receive a direction and extent or offset of the transition effect based on the size and location of the expanded display window defined at 345.

The transition effect, if loaded at 355, may be executed at 365. After the transition effect has run, the transition effect may be removed from the display and the all of a portion of the expanded deliverable content from 355 may be displayed within the expanded display window at 370.

After the expanded deliverable content is delivered at 370, the process 300 may wait for a predetermined second viewer action 375 to initiate restoration of the original web page including the initial deliverable content displayed within the initial display window. The predetermined second viewer action may be, for example, clicking on a “close” button within the expanded display window, clicking on e any element of the web age outside of the expanded content unit, or moving the cursor off of the expanded display window using the mouse or other pointing device.

When the predetermined second viewer action is detected, the web page including the initial display window may be restored at 380. Restoring the original web page may include performing actions that are essentially the inverse of actions taken to expand the display window. The expanded display window and content may be removed, the web page elements hidden at 350 may be unhidden, and the initial display window and the deliverable content loaded at 310 may be restored.

Referring back to FIG. 4, the deliverable content 430 of the content unit 400 may include a video element 434 and a frame element 432. The frame element 432 may include static visual content which may be displayed as a frame around a video image corresponding to the video element 434. Conventionally, such deliverable content is defined by defining a video file and calling a suitable video player from within the frame element. For example, the content may be a Flash element that calls a Flash video player and defines visible and interactive elements that are displayed as a frame around a video image formed by the Flash video player. The Flash frame element may be constrained to a fixed image size, and thus is not expandable. The size of a video image created by a video player is usually definable and thus expandable. However, when called from within a Flash element, the size of the video player image is constrained to fit within the defined size of the Flash element.

To allow continuity of video playback between an initial display window and an expanded display window, the video element 434 and the frame element 432 may be defined as separate elements that are superimposed when displayed. Specifically, the video player that generates the video image is not called from within a fixed-size element such as a Flash element. For example, the frame element 432 may be a Flash element including a transparent window that, when displayed, is superimposed over the video image generated by the video player such that the video image is visible through the window. The Flash frame element 432 may be constrained to a fixed image size, and thus is not expandable. The size of the video image created by the video player may be definable and thus expanded and contracted.

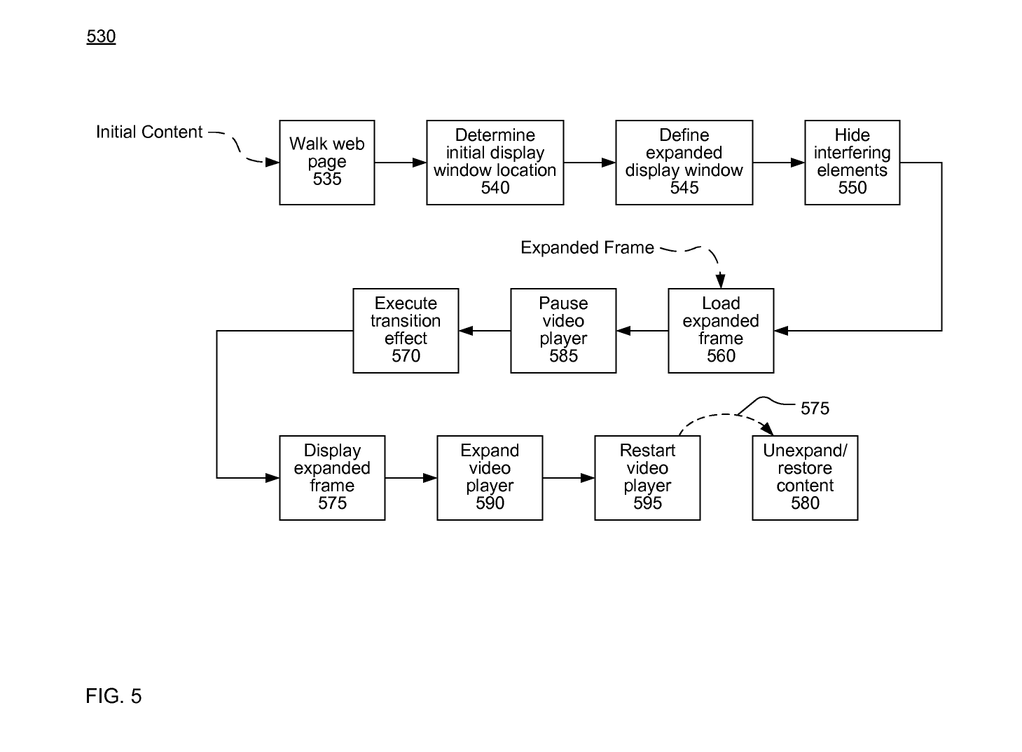

Referring now to FIG. 5, an expansion process 530 may be used instead of the expansion process 330 to expand a content unit that contains a video element, such as the video element 434, and a frame element, such as the frame element 432. The expansion process 530 may maintain continuity of playback of the video element as the content unit is expanded. The actions from 535-580 are similar to the actions 335-375 within the process 300. The actions from 535-580 will be described only to the extent that they differ from the corresponding actions in the process 300.

At 585, the video player may be paused, and the size of the video image created by the video player may be expanded at 590 consistent with a size of an expanded display window defined at 545. The expanded video image may be positioned behind the expanded frame (loaded at 560) within the expanded display window. The video player may be restarted at 595 such that the video image, and accompanying sound if available, continues from the point where the video player was paused at 585.

After a predetermined second viewer action is detected at 575, the initial content may be restored at 580. The continuity of the video presentation may be maintained as the initial content is restored by first pausing the video player, changing the size and location of the video image to its initial configuration, restoring the initial frame, and restarting the video player.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for presenting self-expanding content in a web page displayed by a client computer, comprising:
the client computer receiving, from a server computer, a content unit including initial visual content and a self-contained expansion element
the client computer displaying all or a portion of the initial visual content in an initial display window
after displaying the initial visual content, executing the self-contained expansion element, which causes the client computer to perform actions including:
defining a size and location for an expanded display window larger than the initial display window
hiding elements of the web page determined to interfere with the expanded display window
loading, from the server, expanded visual content
displaying at least a portion of the expanded visual unit in the expanded display window.

2. The method of claim 1, wherein executing the self-contained expansion element, which causes the client computer to perform further actions including:
loading, from the server a transition effect
running the transition effect before displaying the at least a portion of the expanded visual content.

3. The method of claim 1, wherein, executing the self-contained expansion element is done in response to a predetermined first viewer action.

4. The method of claim 3, wherein hiding elements of the web page determined to interfere with the expanded display window comprises:
scanning elements of the web page in sequence to identify elements that interfere with the expanded display window
altering the identified elements to prevent interference with the expanded display window
maintaining a list of altered elements.

5. The method of claim 4, wherein executing the self-contained expansion element, which causes the client computer to perform further actions including restoring the original web page in response to a predetermined second viewer action.

6. The method of claim 5, wherein restoring the original web page further comprises:
removing the expanded content and the expanded display window
restoring the initial content and the initial display window
unhiding elements of the web page in accordance with the list of altered elements

7. The method of claim 1, wherein the initial visual content comprises
a video element which, when played by a video player, generates a resizable video image
an initial frame element configured to be superimposed over the video image, the initial frame element having a transparent portion through which the video image is visible.

8. The method of claim 7, wherein executing the self-contained expansion element, which causes the client computer to perform further actions including:
resizing the video image in accordance with the expanded display window
wherein the expanded visual content is an expanded frame element having a transparent window through which the expanded video image is visible.

9. The method of claim 8, wherein continuity of video playback is achieved between the initial and expanded video images.

10. The method of claim 8, wherein executing the self-contained expansion element, which causes the client computer to perform further actions including:
pausing the video player prior to expanding the video image
unpausing the video player after the expanding the video image and displaying the expanded frame.

11. A method for delivering online content, comprising:
a server computer downloading to a client computer a content unit to be incorporated into a web page, the content unit including:
initial displayable content for display in an initial display window, and
a self-contained expansion element that, when executed by the client computer, causes the client computer to perform actions comprising:
defining a size and location for an expanded display window larger than the initial display window
hiding elements of the web page determined to interfere with the expanded display window
loading, from the server, expanded visual content
displaying at least a portion of the expanded visual unit in the expanded display window.

12. The method of claim 11, wherein executing the self-contained expansion element, which causes the client computer to perform further actions including:
loading, from the server a transition effect
running the transition effect before displaying the at least a portion of the expanded visual content.

13. The method of claim 11, wherein, executing the self-contained expansion element is done in response to a predetermined first viewer action.

14. The method of claim 13, wherein hiding elements of the web page determined to interfere with the expanded display window comprises:
scanning elements of the web page in sequence to identify elements that interfere with the expanded display window
altering the identified elements to prevent interference with the expanded display window
maintaining a list of altered elements.

15. The method of claim 14, wherein executing the self-contained expansion element, which causes the client computer to perform further actions including restoring the original web page in response to a predetermined second viewer action.

16. The method of claim 15, wherein restoring the original web page further comprises:
removing the expanded content and the expanded display window
restoring the initial content and the initial display window
unhiding elements of the web page in accordance with the list of altered elements

17. The method of claim 11, wherein the initial visual content comprises
a video element which, when played by a video player, generates a resizable video image
an initial frame element configured to be superimposed over the video image, the initial frame element having a transparent portion through which the video image is visible.

18. The method of claim 17, wherein executing the self-contained expansion element, which causes the client computer to perform further actions including:
resizing the video image in accordance with the expanded display window
wherein the expanded visual content is an expanded frame element having a transparent window through which the expanded video image is visible.

19. The method of claim 18, wherein continuity of video playback is achieved between the initial and expanded video images.

20. The method of claim 18, wherein executing the self-contained expansion element, which causes the client computer to perform further actions including:
pausing the video player prior to expanding the video image
unpausing the video player after the expanding the video image and displaying the expanded frame.
